(19) United States
(12) Patent Application Publication
(10) Pub. No.: US 2009/0042070 A1
(43) Pub. Date: Feb. 12, 2009

(54) Barometric thermal trap and collection apparatus and method thereof for combining multiple exhaust streams into one

(75) Inventors: Thomas Paul Brown, JR., Acton, CA (US); Sidney Schwartz, Chatsworth, CA (US); James P. Valiensi, Northridge, CA (US)

Correspondence Address: LEONARD TACHNER, A PROFESSIONAL LAW;CORPORATION, 17961 SKY PARK CIRCLE, SUITE 38-E, IRVINE, CA, 92614, US

(73) Assignee: The University Corporation, Inc. at California State university, Northridge

(21) Appl. No.: 11/891,092

(22) Filed: Aug. 8, 2007

(51) Int. Cl. H01M 8/04; F02C 7/00

(52) U.S. Cl. 429/17; 60/783

(57) ABSTRACT

A device that, in any situation where multiple streams of hot or very hot gases or exhaust are generated, can collect gases into one stream and divert the stream efficiently to any manner of reformers, treatment devices, scrubbers, exchangers, etc. The exhaust flow from multiple fuel cell stacks are mixed in a single stream within the invention. This must be done carefully so that the exhaust stack pressure is approximately atmospheric at a variety of operating conditions. The mixing occurs in a device (the invention) called a Barometric Thermal Trap (BaTT). The fuel cell exhaust has a fairly high steam and CO2 content. The steam represents a potentially significant source of latent heat. Typical fuel cell heat recovery units avoid capturing the latent heat due to its relatively low condensing temperature (140 degrees Fahrenheit) and the resultant acidic level of the condensate due to the presence of CO2, which forms carbonic acid. By combining the exhausts into one stream, the BaTT system makes these problems manageable and more cost effective. Design calculations indicate that a Combined Heat and Power (CHP) efficiency of 82% is possible, which is much higher than provided by standard heat recovery designs.

### BACKGROUND OF THE INVENTION

1. Field of the Invention

The present invention relates to the general concept of heat recovery to improve the efficiency of power generating equipment. The invention relates more specifically to a heat recovery system designed for multiple exhaust streams such as the high temperature exhaust streams of molten carbonate fuel cells.

2. Background Art

Molten carbonate fuel cells are designed to operate at higher temperatures than other types of fuel cells and can achieve higher fuel-to-electricity and overall energy use efficiencies than low temperature cells.

In a molten carbonate fuel cell, the electrolyte is made up of lithium-potassium carbonate salts heated to about 1,200 degrees F. (650 degrees Celsius). At these temperatures, the salts melt into a molten state that can conduct charged particles, called ions, between two porous electrodes.

Molten carbonate fuel cells eliminate the external fuel processors that lower temperature fuel cells need to extract hydrogen from the fuel. When natural gas is the fuel, methane (the main ingredient of natural gas) and steam are converted into a hydrogen-rich gas inside the fuel cell stack (a process called “internal reforming”). At the anode, hydrogen reacts with the carbonate ions to produce water, carbon dioxide, and electrons. The electrons travel through an external circuit creating electricity and return to the cathode. There, oxygen from the air and carbon dioxide recycled from the anode, react with the electrons to form carbonate ions that replenish the electrolyte and provide ionic conduction through the electrolyte, completing the circuit.

Molten carbonate fuel cells can reach fuel-to-electricity efficiencies approaching 50%, considerably higher than the 37-42% efficiencies of a phosphoric acid fuel cell plant. When the waste heat is captured and used, overall thermal efficiencies can be as high as 85 percent.

Heat recovery systems are generally fitted to fuel cell installations because of their high exhaust temperatures. The heat can be recovered and used to heat water or air with the use of heat exchangers, thus obviating additional purchased energy for those needs. Due to exhaust duct back pressure limitations and a risk of damage from errant draw through of cold air across a hot stack, multiple independent fuel cell units are designed to have an individual heat recovery unit attached to each individual exhaust stack. This was perceived as inefficient for effective heat recovery and CO2 management purposes and thus the concept of bringing all exhaust streams together, was posed. What was needed was a way of improving the economics by reducing the number of individual heat exchangers required, to increase the overall efficiency of heat recovery as compared to single stream recovery of each fuel cell and thereby reducing the footprint of the overall plant with a single heat exchanger. Moreover, this uniquely allows for specialized management of exhaust gas streams such as CO2 recycling and latent heat recovery.

### SUMMARY OF THE INVENTION

The invention is a device that, in any situation where multiple streams of hot or very hot gases or exhaust are generated, can collect gases into one stream and divert the stream efficiently to any manner of reformers, treatment devices, scrubbers, exchangers, etc., (collectively known as Handlers). The collection of multiple discharge streams of exhaust and/or waste gas or vapor provides a controllable and more efficient means to deliver the collected streams to a single handler. The device may be used to retrofit multiples of equipment producing hot gas flow streams for the purpose of heat recovery, condensation recovery or any other manner of treatment, recovery, mixing, extraction, etc.

The particular fuel cell plant for which the disclosed embodiment was designed consists of four individual fuel cell units that each produce a very hot exhaust stream. The nature of this equipment is such that it is very sensitive and prone to failure should the exhaust gas flow be excessively restricted, or should other cold gas be drawn through the equipment once it goes off line (shuts down). For these reasons the fuel cell industry (as well as manufacturers of gas turbine, microturbine, and other equipment) have typically advocated installation of an individual heat recovery system for recovering the waste heat for each individual fuel cell unit. To address these concerns, we have designed and constructed this advantageous invention.

The exhaust flow from multiple fuel cell stacks are mixed in a single stream within the invention. This must be done carefully so that the exhaust stack pressure is approximately atmospheric at a variety of operating conditions. The mixing occurs in a device (the invention) called a Barometric Thermal Trap (BaTT).

The fuel cell exhaust has a fairly high steam and CO2 content. The steam represents a potentially significant source of latent heat. Typical fuel cell heat recovery units avoid capturing the latent heat due to its relatively low condensing temperature (140 degrees Fahrenheit) and the resultant acidic level of the condensate due to the presence of CO2, which forms carbonic acid. By combining the exhausts into one stream, the BaTT system makes these problems manageable and more cost effective. Design calculations indicate that a Combined Heat and Power (CHP) efficiency of 82% is possible, which is much higher than provided by standard heat recovery designs.

The (BaTT) heat recovery unit design for this plant has at least these unique features:
The fuel cell plants' four exhaust streams are collected in the BaTT and directed to a single heat recovery unit (heat exchanger).
The design of the BaTT is such that an atmospheric balance (across the prime hot gas generating equipment) is always maintained to eliminate the need for appurtenant devices to manage the flow of the multiple gas streams.
The duct connection to the BaTT has a zero stress slip joint to facilitate the linear expansion of the duct resulting from thermal expansion.
The BaTT system is intrinsically safe without any mechanical devices to fail and cause resultant failure or damage to connected equipment.

For maximum efficiency, the heat recovery system has been designed to be compatible with the particular energy requirements of a particular installation. The incorporation of the recovery of latent heat in the design of the heat recovery system has allowed the fuel cell plant to have significantly higher combined heat and power efficiencies than the standard values, based on the performance of a heat recovery unit which is offered as an add-on option for purchasers of the fuel cell units. This increased efficiency is due to the latent heat recovery, which without the BaTT gas collection system would have been very costly to implement and maintain.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional view of a preferred embodiment of the invention in an installation for receiving four individual exhaust streams;

FIG. 2 is a partially cut-away and partially phantom view of the installation of FIG. 1;

FIG. 3 is a cross-sectioned top view of the main section of the embodiment of FIG. 1;

FIG. 4 is a cross-sectioned side view of the main section of the embodiment of FIG. 1;

FIG. 5 is a partially cross-sectioned side view of the entire assembly of FIG. 1;

FIG. 6 is an enlarged cross-sectioned view of a slip joint used in the preferred embodiment;

FIG. 7 is an enlarged cross-sectioned view of the insulated housing structure of the preferred embodiment; and

FIG. 8 is a schematic block diagram of the preferred embodiment of the complete system of the invention.

### DETAILED DESCRIPTION OF A PREFERRED EMBODIMENT

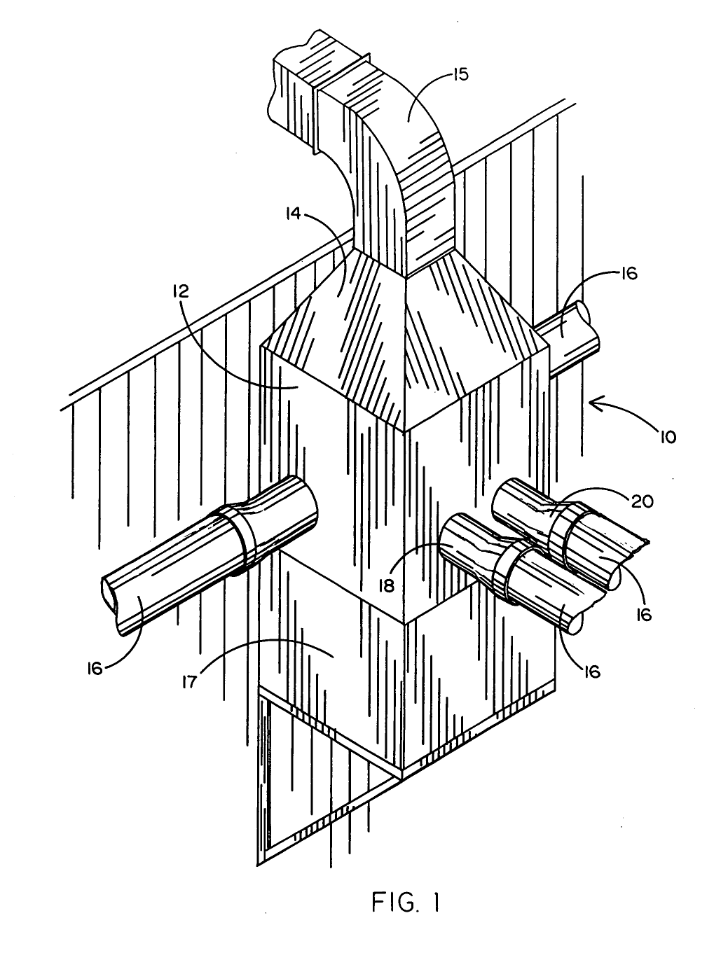

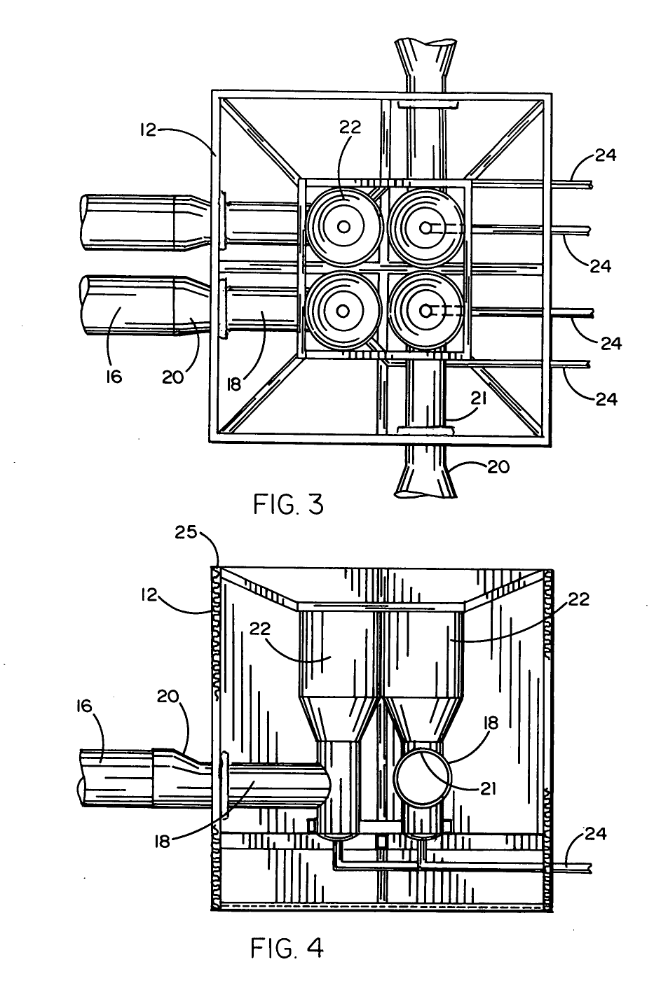

Referring to the accompanying drawings and FIGS. 1-7 in particular, it will be seen that a thermal trap and collection system 10 comprises a main section 12, an upper section 14 and a lower section 17. The main section 12 receives a plurality of individual input exhaust ducts 16 from remotely located fuel cell units (not shown) and the upper section 14 leads into a unitary combined output exhaust duct 15.

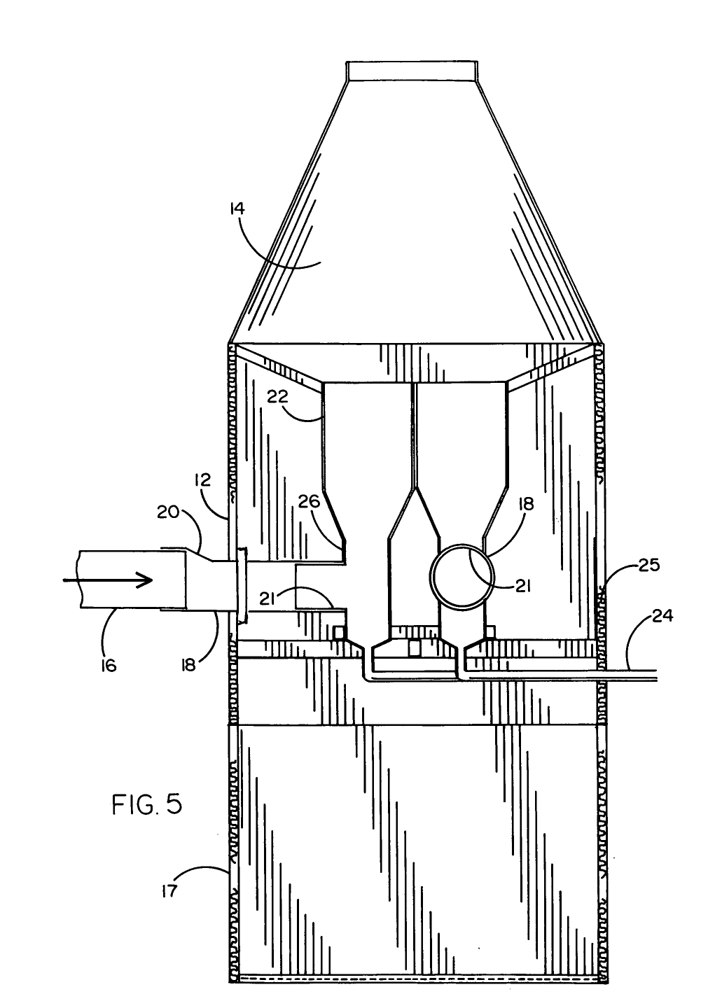

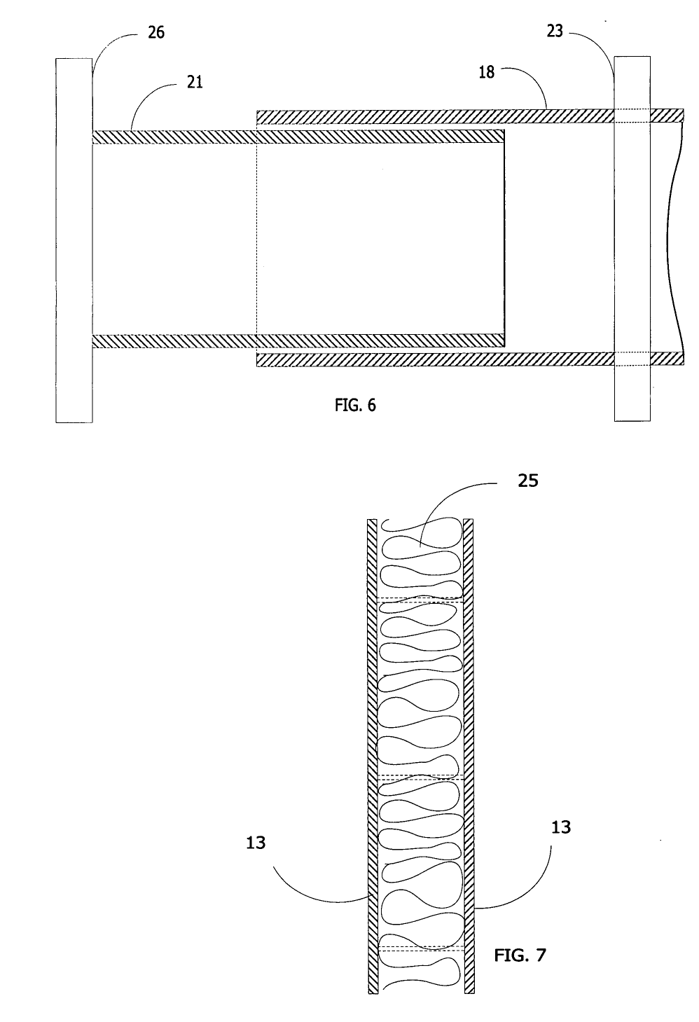

Each input duct 16 mates with a corresponding receiving duct 18 via a respective tapered joint 20. Each receiving duct 18 is supported at the main section housing by means of a slip flange 23, which is secured to the housing face, but is in unconnected sliding relation with duct 18. Duct 18 passes through an aperture in the main section housing where it extends internally toward a corresponding vertically oriented collector 22 by means of a flange 26 to which an internal horizontally extending nipple 21 is affixed. The opposing end of duct 18 rests on nipple 21 in free standing “slip” relation as seen best in FIGS. 5 and 6, forming the slip joint of the invention.

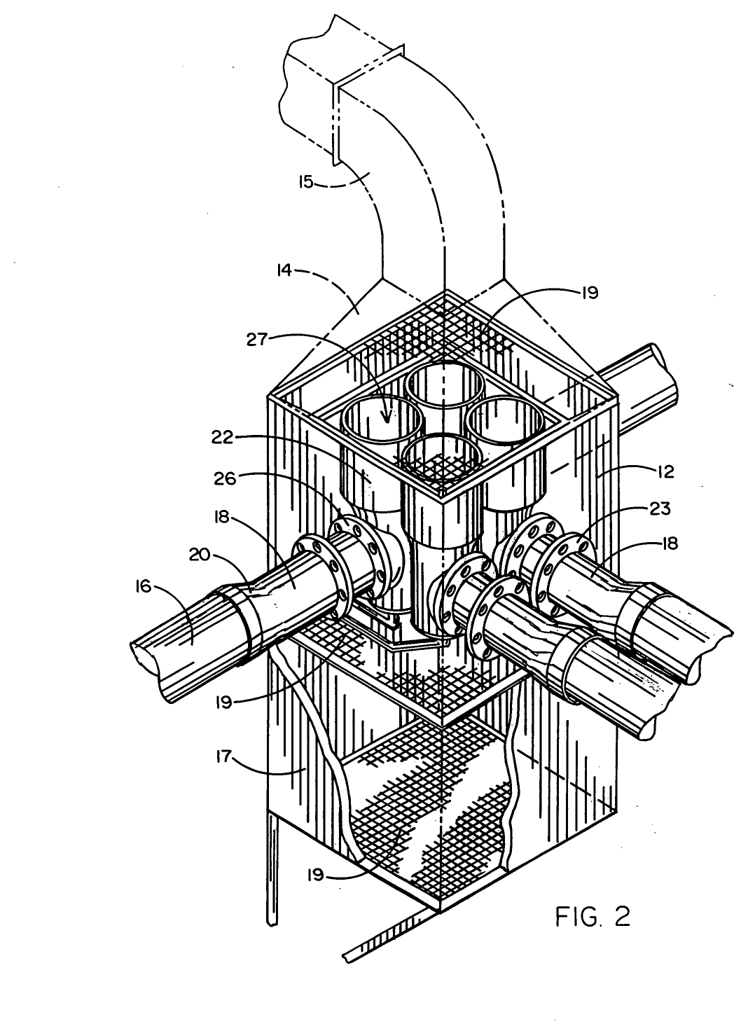

The collectors 22 are vertically-directed as seen best in FIGS. 2, 4, and 5 and taper outwardly toward open upper ends 27 which direct the respective high temperature exhaust streams toward the frusto-pyramidal shaped upper section 14 (see FIGS. 1, 2 and 5) to which the unitary output exhaust duct or plenum 15 is connected. The lower end of each collector 22 is connected to a respective corresponding drip leg and gas sampling pipe 24. Pipes 24 are fed to instrumentalization (not shown) to permit monitoring by personnel and/or automatic sensors. The top and bottom openings of main section 12 and bottom section 17 are covered by an open steel mesh such as bird screen 19 seen in FIG. 2. The walls of the respective sections 12, 14 and 17 are each made of dual S.S. T316 steel 14 gauge panels 13 insulated with a mineral wool insulation 25 therebetween as shown in FIG. 7. Ducts 16 and 18 are preferably also made of S.S. T316 steel of a lighter gauge such as 18 or 20 gauge.

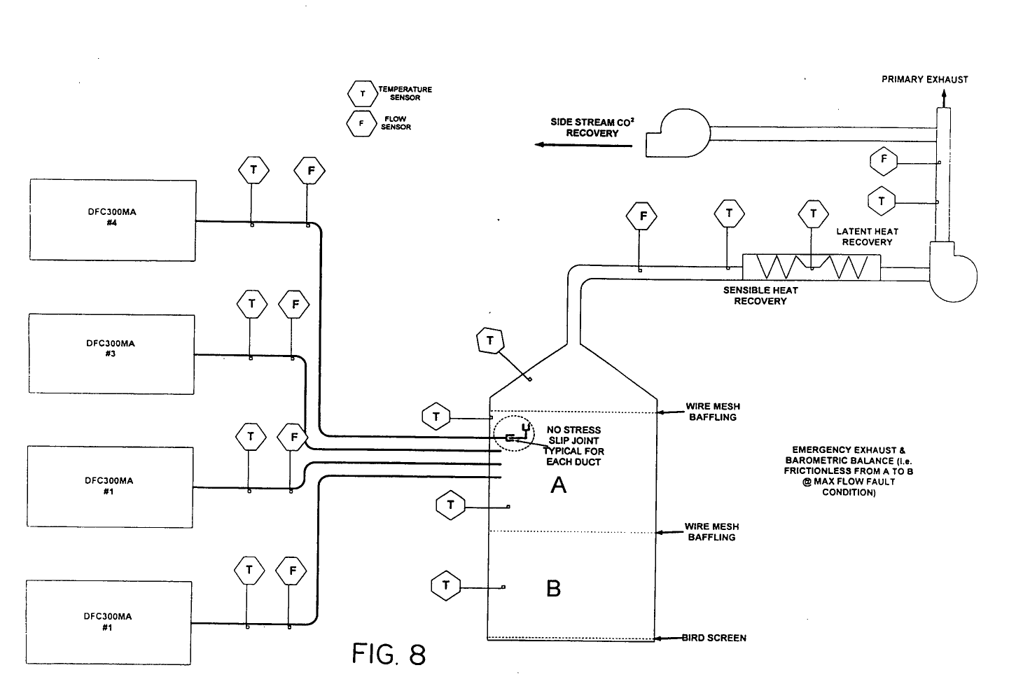

A simplified schematic representation of the entire system, including the inventive thermal trap, is shown in FIG. 8. As seen therein, the preferred embodiment is configured to provide sensible and latent heat recovery from four distinct molten carbonate fuel cells (in this case Alliance Power, Inc. DFC® 300 MA fuel cell units each generating 250 KW of electrical power).

Hot exhaust gas exits each (4 each DFC 300MA Fuel Cell modules) of multiple process equipment and is ducted individually to the Barometric Thermal Trap (BaTT). Each of these exhaust flows is individually metered for temperature and flow prior to entering the trap. Each individual exhaust duct transitions through a trap sidewall simple support flange (slip joint) and an internal no stress (pipe in pipe) slip joint, allowing thermal expansion and contraction of the duct material during start up and cool down phases. Because the interior (and exterior) of the BaTT is at barometric pressure, there is no concern of gas leakage (in or out) from the sidewall simple support flange (slip joint) at the wall. Even though the ducted pipe within the trap is under some (exhaust gas) pressure, the internal no stress (pipe in pipe) slip joint is contained within the trap, and the trap captures the hot gases contained within it's enclosure, so there is no need for conventional fully contained highly stressed pipe expansion joints, and a pipe in pipe close tolerance slip joint with limited allowable leakage is most efficient.

The individual hot gas ducts upon entering the trap, are directed into a tee pipe section. The bottom of this tee is reduced to a ¾″ pipe and piped outside of the trap. These ¾″ lines act as a condensate trap and provide a convenient remote source for drawing specific gas samples of the exhaust gases from each individual piece of process equipment.

The top of the tee is concentrically belled out (to a larger diameter pipe) to allow the buoyant hot gases to be naturally directed up while slowing the velocity and reducing the pressure of the hot gas as it enters the barometric zone of the trap.

Within the trap (at top and bottom of the middle 4′ primary internal section) are two wire mesh dampening baffles that promote the creation of a non-turbulent fluid boundary between the hot exhaust gases and the outside air. An optimal non-turbulent fluid boundary reduces convective losses to a minimum from the open bottom of the trap, and any conductive losses through the open bottom 4′ apron section of the trap are then negligible (less than the thermal losses through the same area of 6″ thick insulation of medium density mineral wool). At the very bottom of the trap is a bird screen to prevent animals from errantly entering the trap.

Along the vertical length of the trap are additional temperature sensors spaced equally and arranged to best determine the creation and location of a defined thermal fluid boundary. These sensors are used as a feedback signal to the process variable in the primary control scheme for the primary exhaust fan.

The hot gases are drawn out of the top of the trap at the same volumetric rate as they are cumulatively delivered into the trap by the individual exhaust gas ducts from the various process equipment (DFC 300MA's). At the main exhaust duct exiting from the trap, the total flow and aggregate temperature is metered just prior to entering the heat recovery coils. The totalized flow as measured at that primary duct location is used as the control variable (while the sum total of the 4 individual duct flows is set as the process variable) to control the speed of the primary exhaust fan. The fan speed control is managed via a proportional/integral action digital control loop with the location of the thermal fluid boundary within the trap having a slight feedback function on the control algorithm.

The primary exhaust fan also draws the desired volume of hot exhaust gases across the heat recovery coils. A high grade sensible heat recovery coil, as well as a lower grade latent heat recovery coil (condensing temperature is approximately 140 deg F.) is installed to optimize the heat recovery of the system. In the case of (molten carbonate) fuel cell exhaust, a substantial portion of the heat recovery opportunity lies within a latent form (due to the hydrogen reaction forming a high percentage of superheated steam within the exhaust stream). Because there is also a high percentage of CO2 within this exhaust stream, the condensation resulting from latent heat recovery is in the form of carbonic acid. The trap allows this heat recovery and resultant condensate to be managed centrally. The management of an acidic condensate from multiple individual unit exhaust streams has proven to be complex and cost prohibitive and has prevented the industry from capturing the latent heat on most other installations of this type equipment.

The exhaust gases from the trap primary draw through exhaust fan exits to the atmosphere through a ducted chamber, while side stream CO2 rich exhaust may be drawn off from this ducted chamber for capture or reuse of the CO2. Two side stream flows are being developed from this particular installation. One is to be delivered to a research greenhouse for CO2 enrichment research on plant life. A second source is drawn off and delivered into a specially developed outdoor sub tropical environment to sustain this specialized environment while helping to mitigate the total emission of CO2 into the environment.

Table I below compares the combined heat and power efficiency (calculated) of a plurality of individual heat recovery units as offered by the fuel cell manufacturer with the CHP efficiency of the present invention as calculated for the disclosed embodiment.

TABLE 1

| | | DFC ® 300 MA UNITS WITH |
|---|---|---|
| | | INVENTIVE HEAT |
| | DFC ® 300 MA UNITS WITH | RECOVERY UNIT |
| | ALLIANCE POWPER, INC. | (THERMAL NUMBERS |
| PERFORMANCE | HEAT RECOVERY | FROM DESIGN |
| PARAMETER | SYSTEM | CALCULATIONS) |
| Power Output | 1000 kW | 1000 kW |
| Electrical Efficiency | 45% (based on LHV) | 45% (based on LHV) |
| Waste Heat Recovered | 1.4E6 Btu/hr (cooled to | 2.7E6 Btu/hr (cooled to |
| (cooled to specified | 250° F.) | 140° F.) |
| temperature) | | |
| Latent Heat Recovered | None | 1.1E6 Btu/hr |
| CHP Efficiency | 64% | 82% |

Having thus a description of a preferred embodiment of the invention, those having skill in the relevant arts will now perceive various modifications and additions which may be made thereto without deviating from the principal features thereof. By way of example, while the illustrated embodiment combines multiple exhaust streams for heat recovery, another embodiment may be used primarily for recovery of greenhouse gases such as CO₂. Accordingly, it will be understood that the scope hereof is to be limited only by the appended claims and their equivalents and not by the disclosure of the illustrated embodiment which is made solely for the purpose of meeting the statutory requirements for obtaining a patent.

We claim:

1. An apparatus for combining multiple heat exhaust streams from a plurality of heat exhaust generating devices in relative proximity for more efficiently recovering sensible and latent heat from the exhaust streams for useful application; the apparatus comprising:
a plurality of ducts connected respectively to said power generating devices for conveying said multiple exhaust streams individually to said apparatus;
a plurality of collectors arranged for redirecting said multiple exhaust streams in said plurality of ducts into a unitary plenum; and
an insulated housing containing said plurality of collectors in an ambient barometric environment.

2. The apparatus recited in claim 1 further comprising:
a plurality of slip assemblies, each such assembly being interposed between a respective one of said ducts and a respective one of said collectors for maintaining exhaust stream flow therebetween despite changing thermal-stress-induced relative mechanical movement.

3. The apparatus recited in claim 2 wherein each said slip assembly comprises a receiving duct extending in slip relation from a corresponding nipple of a collector and terminating in a slip joint receiving a power generating device duct in co-axial relation therewith and without substantial resistance to relative movement therebetween.

4. The apparatus recited in claim 3 wherein each said receiving duct extends through a corresponding respective aperture in said insulated housing and wherein each said aperture is bordered by a slip flange for supporting said receiving duct without substantially resisting linear movement of said receiving duct through said aperture.

5. The apparatus recited in claim 1 further comprising:
a frusto-pyramidal top section installed on top of said housing for interconnecting said plurality of collectors and said unitary plenum.

6. The apparatus recited in claim 1 wherein each of said heat exhaust generating devices comprises a molten carbonate fuel cell.

7. A method of combining multiple exhaust streams from a plurality of heat exhaust generating devices in relative proximity for more efficiently recovering a product from the exhaust streams for useful application; the method comprising the steps of:
a) conveying said exhaust streams through a plurality of respective ducts to a substantially unitary location;
b) providing at said unitary location a plurality of collectors arranged for redirecting said multiple exhaust streams in said plurality of respective ducts into a unitary plenum; and
c) containing said plurality of collectors within an insulated housing enclosing an ambient barometric environment.

8. The method recited in claim 7 further comprising the step of connecting said respective ducts to said collectors through a plurality of slip assemblies, each such assembly being interposed between a respective one of said ducts and a respective one of said collectors for maintaining exhaust stream flow therebetween despite changing thermal-stress-induced relative mechanical movement.

9. The method recited in claim 8 comprising the step of providing each said slip assembly with a receiving duct that is configured for relative thermally-induced movement between a respective one of said power generating device ducts and a respective one of said collectors.

10. The method recited in claim 7 further comprising the step of interposing a frusto-pyramidal section between said housing and said plenum for forming a unitary output exhaust stream from said collectors.

11. The method recited in claim 7 wherein said product recovered from said exhaust streams is sensible and latent heat.

12. The method recited in claim 7 wherein said product recovered from said exhaust streams is CO₂.
